(19) United States
(12) Patent Application Publication
(10) Pub. No.: US 2002/0119383 A1
(43) Pub. Date: Aug. 29, 2002

(54) Electrophotographic photoconductor and electrophotographic apparatus

(76) Inventors: Hidetaka Yahagi, Nagano (JP); Mikio Takashima, Nagano (JP); Seizo Kitagawa, Nagano (JP); Mizuhiro Shimizu, Nagano (JP)

Correspondence Address: ROSSI & ASSOCIATES, P.O. Box 826, Ashburn, VA, 20146-0826, US

(21) Appl. No.: 09/950,556

(22) Filed: Sep. 12, 2001

(30) Foreign Application Priority Data
Sep. 14, 2000 (JP) 2000-280369

(51) Int. Cl. G03G 5/10

(52) U.S. Cl. 430/69

(57) ABSTRACT

An electrophotographic apparatus utilizes a photoconductor which avoids a concentration of electric field due to the voltage applied from the charging member to the irregular spot on the outer surface of the cylindrical conductive substrate, and as a result, electrical breakdown of the photosensitive layer is suppressed and lowering of the charged voltage is prevented, so that a critical printing fault, such as a black spot on the printed material, does not occur. The photoconductor includes a cylindrical conductive substrate and an organic photosensitive layer on the outer surface of the substrate, and is used in an electrophotographic system including a contact charging process, wherein the outer surface of the substrate is finished to a mirror surface by means of surface cutting.

### FIELD OF THE INVENTION

The present invention relates to an electrophotographic photoconductor method and apparatus in which a contact charging process is employed as a surface charging method in at least one process in an electrophotographic system.

### BACKGROUND OF THE INVENTION

An electrophotographic apparatus employing an electrophotographic photoconductor (photoconductor) was, at the beginning, practically applied mainly to copying machine, which was the first electrophotographic apparatus applying a photoconductor. In recent years, in addition to the copying machines, the electrophotographic apparatus are widely used in laser-beam printers and facsimile machines as main applications, taking advantages of their higher image quality, high quality and low noise, and the application range is now rapidly extending.

Charging a photoconductor for use in a copier and a printer has been generally performed by a charger based on corona discharge, such as a corotron or a scorotron. This corona charger requires high voltage of 4 to 7 kV for charging a photoconductor, and yet has a large size. The corona charger has a drawback that it generates a volume of ozone and adversely affects an organic photosensitive layer due to the strong oxidizing ability of the ozone, accelerating deterioration of the organic photoconductor. Recently, there is a growing recognition of the environment on the one hand, and an apparatus such as a printer is used nearer to a human body like a place on the desk as a result of its miniaturization and personalization, on the other hand. Accordingly, such a charging apparatus has been demanded that generates minimum ozone, which is harmful to the human body, and has a small size.

Under these circumstances, contact charging methods such as roller charging and brush charging are drawing attention. The roller charging is a method for charging photoconductor surface, in which a roller having a core of metal and a cover of conductive rubber contacts a photoconductor and a voltage is applied between the metal core and the photoconductor. This charging method can be managed with low voltage and generates little ozone.

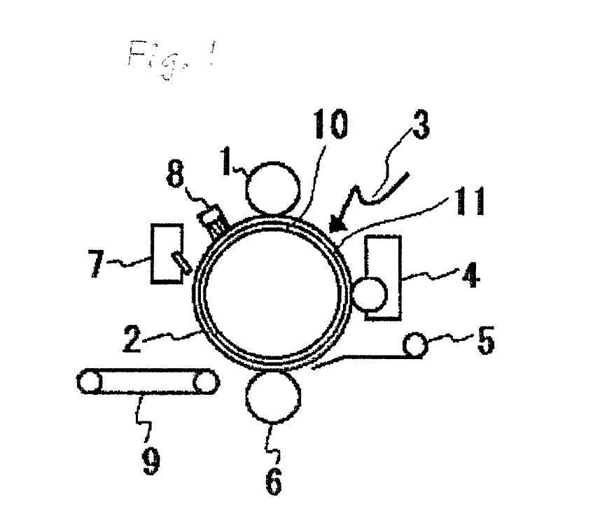

FIG. 1 is a schematic drawing showing an electrophotographic apparatus comprising an electrophotographic process employing a contact charging method. This apparatus comprises a photoconductor 2 composed of a cylindrical conductive substrate 10 and an organic photosensitive layer 11 coated on the outer surface of the substrate, and the parts arranged along the peripheral of the photoconductor, the parts including a roller charging member 1, an image exposure device 3, a developer 4, paper-supplying roller and guide 5, a direct-charging type transfer charger 6, a cleaner 7 and a charge elimination device 8. Image formation in this apparatus proceeds as follows. First, the surface of the photoconductor 2 is charged by applying voltage to the roller charging member 1 that is arranged to contact with the photoconductor 2. The image exposure device 3 projects an image of the original onto the photoconductor, forming an electrostatic latent image. The latent image on the photoconductor is then developed, that is, visualized by attaching the toner powder onto the photoconductor. The toner image formed on the photoconductor 2 is transferred by the transfer charger to the transfer material, such as paper supplied through the paper-supply roller and guide 5. The toner that is not transferred to the transfer material and remains on the photoconductor is recovered by the cleaner 7. If any charges remain in the photoconductor, it is better to eliminate the charges by applying an appropriate voltage to the photoconductor using the charge elimination device 8, or eliminate the charges using light. The transfer material carrying a toner image is transported by the conveyer 9 to a fixing device, not shown in FIG. 1, and fixed there.

For a light source of the image exposure device 3 in this electrophotographic apparatus, a halogen lamp, a fluorescent lamp or a laser light may be used. Any other process may be added to the electrophotographic apparatus as needed.

The electrophotographic apparatus may be applied not only to a copier but also to a laser beam printer and an electrophotographic platemaking system.

The contact charging method such as roller charging or brush charging has certain drawbacks that are caused by direct contact of a charging member such as a charging roller or a conductive brush with the photoconductor. If there is an irregularity on the surface of the photosensitive layer of the photoconductor or on the surface of the conductive substrate of aluminun supporting the photosensitive layer, concentration of electric field occurs at the projecting spots by the voltage applied by the charging member, which induces electric breakdown in the photosensitive layer. The charged potential of the portion of the breakdown lowers, and black spots on the printed material arise in the case of reverse development, which is a critical fault in the printing. The concentration of electric field by the applied voltage is a problem not only in the charging process, but also in the process of image transfer or charge elimination so far as the contact charging method is employed.

It is known that if a pin-hole exists in the photosensitive layer, an electric breakdown occurs and the charged potential lowers at the pin-hole spot, resulting in an image defect.

The photoconductor having such a pin-hole may be excluded and not used. Alternatively, it is known that even if the photosensitive layer has a pin-hole, the current concentration towards the spot may be avoided by coating the surface of the charging roller, which is at the side of charging electric potential, with a high resistivity layer.

Moreover, Japanese Unexamined Patent Application Publication Nos. H5-80567 and H5-34964 disclose that the above-described electric breakdown is prevented by providing an intermediate layer between the aluminum substrate and the photosensitive layer, in which the intermediate layer is an alumite film obtained by anodizing aluminum.

Japanese Unexamined Patent Application Publication No. H5-216263 discloses that an image defect is avoided, even when a pinhole exists, by making breakdown voltage of the intermediate layer of an alumite film or an organic resin film greater than a specified value.

Japanese Unexamined Patent Application Publication No. H8-254840 discloses that partial breakdown and lowering of the withstand voltage caused by irregularities of the substrate are prevented when the ten point height of irregularities Rz of the substrate surface is not more than 0.8 μm.

A photoconductor generally takes a function-separated laminated-layer structure, in which an outer surface of a cylindrical substrate of conductive metal is coated with a photosensitive layer made of organic material as a principal component and containing photoconductive material. Aluminum or aluminum alloy is widely used for the cylindrical substrate of conductive metal.

The aluminum substrate is manufactured through steps of (1) melting aluminum ingot, (2) adjusting alloy elements, (3) casting, (4) cutting burette, (5) hot extrusion, (6) cold drawing, (7) cutting, and (8) surface cutting. In the surface cutting, which is a final step, the surface is generally finished so that the maximum height of irregularities Ry is in the range of 0.6 to 1.2 μm.

It is therefore an object of the present invention to provide an electrophotographic photoconductor that is free of a critical printing fault such as a black spot on the printed material in the case of reverse development by means of avoiding concentration of electric field that may be caused by voltage applied from the charging member to the irregularities on the outer surface of the cylindrical conductive substrate, and as a result, preventing the photosensitive layer from electrical breakdown and preventing the charged voltage from lowering. It is another object of the present invention to provide an electrophotographic apparatus using such a photoconductor.

### SUMMARY OF THE INVENTION

The object of the present invention is attained by a photoconductor comprising a cylindrical conductive substrate and an organic photosensitive layer on an outer surface of the substrate, the photoconductor being used in an electrophotographic system including a contact charging process, wherein the outer surface of the substrate is finished to a mirror surface by means of surface cutting.

Advantageously, the mirror surface has a maximum height of irregularities Ry of not more than 0.5 μm.

An electrophotographic apparatus of the invention comprises the above-described photoconductor of the present invention, and performs at least one process of charging, image transfer or charge elimination by means of applying voltage with a contact charging method.

### BRIEF DESCRIPTION OF THE DRAWINGS

The invention will now be described with reference to certain preferred embodiments thereof and the accompanying drawing identified as FIG. 1, which is a schematic drawing showing a constitution of an electrophotographic apparatus according to the present invention,

### DETAILED DESCRIPTION OF THE INVENTION

### EXAMPLE 1

An aluminum tube made of an aluminum alloy: JIS-A6063 (JIS stands for Japanese Industrial Standards) was worked by hot extrusion and cold drawing to a diameter of 30 mm and a thickness of 0.75 mm, and cut to a length of 335 mm by a lathe. The surface of the aluminum substrate was finished to a mirror surface of maximum height of surface irregularities Ry=0.2 μm using a cutting tool with a natural diamond tip and cutting oil: METALWORK ED manufactured by Nippon Oil Co., Ltd., with cutting speed of 0.2 mm/rev. The aluminum substrate was washed at room temperature with liquid of 2 wt % alkali detergent: CASTROL 450 available from Castrol Co., Ltd. The above-described surface roughness is in conformity to the specification of JIS B0601-1994. The following description on surface roughness is also based on the specification.

The cleansed aluminum substrate was dip-coated with separately prepared coating liquid that is a methylene chloride solution of a polyamide resin: CM8000, to form a undercoat layer with a dried thickness of 0.1 μm. This substrate was then dip-coated with a coating liquid for charge generation layer that is a methyl chloride solution of τ-type metal-free phthalocyanine plus vinyl chloride-vinyl acetate copolymer resin, to form a charge generation layer having a dry thickness of 0.5 μm. After heating to dry, the substrate with the charge generation layer on the surface thereof was dipped in a coating liquid for a charge transport layer that is a methylene chloride solution of hydrazone compound plus polycarbonate copolymer resin, to form a charge transport layer of 25 μm thick. After heating to dry, an electrophotographic photoconductor was obtained.

### EXAMPLE 2

A photoconductor was produced in the same manner as in Example 1 except that the surface of the aluminum substrate was finished to a mirror surface with maximum height Ry=0.23 μm using a flat cutting tool with an artificial polycrystalline diamond tip.

### EXAMPLE 3

Photoconductors were produced in the same manner as in Example 1 except that each surface of the aluminum substrates was finished to a mirror surface with maximum height Ry0.32 μm or 0.43 μm using an R cutting tool with an artificial polycrystalline diamond tip.

### Comparative Example 1

Photoconductors were produced in the same manner as in Example 1 except that each surface of the aluminum substrates was finished to a rough surface with maximum height Ry=0.62 μm, 0.70 μm or 0.83 μm using a flat cutting tool with an artificial polycrystalline diamond tip.

### Comparative Example 2

Photoconductors were produced in the same manner as in Example 1 except that each surface of the aluminum substrates was finished to a rough surface with maximum height Ry=0.59 μm, 0.74 μm or 0.81 μm using an R cutting tool with an artificial polycrystalline diamond tip.

### Comparative Example 3

Photoconductors were produced in the same manner as in Example 1 except that aluminum alloy for the substrate was changed to JIS-A3003, and the aluminum cylinder was cut after cold drawing was used without any surface cutting. The maximum height of irregularities along axial direction was Ry=0.40 μm.

Although the above description was made on the laminated-layer type photoconductor, the effect of the present invention is attained in a photoconductor with a photosensitive layer of a single-layer type. A charge elimination device in an electrophotographic apparatus using a single-layer type photoconductor is preferably a device employing a contacting brush.

### Evaluation of the Photoconductors

Evaluations were made on the Examples 1 to 3 and the Comparative Examples 1 to 3 as follows. Visual observation was made whether electrical breakdown was occurred or not by application of voltage on the photoconductor surface. In addition, printing was performed using a printer: PCPR2000 manufactured by NEC Corp. and the printed condition was examined. The results of the evaluations are given in Table 1.

TABLE 1

| | | Surface | Max. Height | | Printing |
|---|---|---|---|---|---|
| | Cutting Tool | Condition | Ry [μm] | Breakdown | Fault |
| Example 1 | natural diamond | mirror | 0.20 | not detected | not detected |
| Example 2 | artificial diamond | mirror | 0.23 | not detected | not detected |
| Example 3 | artificial diamond | mirror | 0.32 | not detected | not detected |
| | artificial diamond | mirror | 0.43 | not detected | not detected |
| Comparative | artificial diamond | rough | 0.62 | detected | black spot |
| Example 1 | artificial diamond | rough | 0.70 | detected | black spot |
| | artificial diamond | rough | 0.83 | detected | black spot |
| Comparative | artificial diamond | rough | 0.59 | detected | black spot |
| Example 2 | artificial diamond | rough | 0.74 | detected | black spot |
| | artificial diamond | rough | 0.81 | detected | black spot |
| Comparative | no cutting | rough | 0.40 | detected | black spot |
| Example 3 | | | | | |

As apparent from Table 1, electrical breakdown and printing defects were not detected in Examples 1 to 3, which were finished by surface cutting to a mirror surface with the maximum height Ry not more than 0.5 μm. In contrast, in the Comparative Examples 1 and 2, which had rough surface with Ry greater than 0.5 μm, electrical breakdown was detected that occurred when voltage was applied to the photoconductor surface, and black spot defects were also detected in the printing. Comparative Example 3 has a small maximum height Ry value of 0.40 μm. The surface is in an as-drawn condition and not processed by surface cutting. The as-drawn surface is very smooth along the axial direction of the tube, while in the circumferential direction it shows large irregularities. The surface roughness of the substrate of Comparative Example 3 was measured along axial direction like in the other samples and showed a small value of 0.40 μm. However, measuring along the circumferential direction showed the large value of more than 1.0 μm, thus the surface is by no means a mirror surface.

Table 1 clearly shows that an electrical breakdown is effectively avoided in a photoconductor employing a substrate, in which the surface thereof is finished by surface cutting using a cutting tool to a mirror surface with the maximum height Ry of not more than 0.5 μm.

A photoconductor according to the present invention comprises a cylindrical conductive substrate and an organic photosensitive layer on the outer surface of the substrate and is used in an electrophotographic system including a contact charging process. The outer surface of the substrate of the photoconductor of the invention is finished to a mirror surface by means of surface cutting. An electrophotographic apparatus of the invention uses such a photoconductor. Such a photoconductor avoids concentration of electric field that may be caused by the voltage applied from the charging member to the irregularities on the outer surface of the cylindrical conductive substrate. As a result, electrical breakdown of the photosensitive layer is suppressed and lowering of the charged voltage is prevented. Therefore, a critical printing fault such as a black spot on the printed material in the case of reverse development is avoided.

What is claimed is:

1. An electrophotographic photoconductor comprising:
a cylindrical conductive substrate; and
an organic photosensitive layer on an outer surface of said substrate;
wherein said photoconductor is used in an electrophotographic system including a contact charging process; and
wherein said outer surface of said substrate is finished to a mirror surface by means of surface cutting.

2. An electrophotographic photoconductor according to claim 1,
wherein said mirror surface has a maximum height of irregularities Ry of not more than 0.5 μm .

3. An electrophotographic apparatus according to claim 1,
wherein said photoconductor performs at least one process of charging, image transfer or charge elimination by means of applying voltage with a contact charging process.
